(19) United States
(12) Patent Application Publication
(10) Pub. No.: US 2025/0277334 A1
(43) Pub. Date: Sep. 4, 2025

(54) Stream Generator

(71) Applicant: ZhenLing Qu, Shenzhen (CN)

(72) Inventor: ZhenLing Qu, Shenzhen (CN)

(21) Appl. No.: 18/624,999

(22) Filed: Apr. 2, 2024

(30) Foreign Application Priority Data
Mar. 2, 2024 (CN) 202420400285.7
Mar. 2, 2024 (CN) 202420400289.5

(51) Int. Cl. D06F 75/10; H05B 1/02

(52) U.S. Cl. CPC D06F 75/10; H05B 1/0255; H05B 2203/005

(57) ABSTRACT

A stream generator includes a heat conduction base, a first heating device and a second heating device. The first heating device and the second heating device are embedded in a middle part of the heat conduction base. A first heating cavity and a second heating cavity are respectively arranged at bottom and top of the heat conduction base; the first heating cavity is provided with a plurality of first heating compartments connected in sequence; the second heating cavity is provided with a plurality of second heating compartments connected in sequence. It has the advantage of extending the heating range to ensure sufficient vaporization and stronger adaptability.

### FIELD OF THE INVENTION

The present utility patent handheld steam ironing machine, in particular, for a steam generator.

### BACKGROUND OF THE INVENTION

A handheld steam ironing machine is a machine that continuously contacts clothes with hot water vapor to soften the fibrous tissue of the clothes. Through the movement of pulling and pressing, a handheld steam ironing machine makes the clothes smooth. By spraying at wrinkles of clothes, a handheld steam ironing machine makes clothes smooth and supple. Without using an ironing board and tedious steps of usual ironing, one can do the ironing well. The hot water vapor has cleaning and disinfecting effect as well. As a result, handheld steam ironing machines have been widely used in clothing stores, inns, hotels, families, and so on.

The existing portable handheld steam ironing machine includes a shell and a nozzle. A steam generator is arranged in the shell. A steam generating cavity is arranged on the steam generator. Cold water from the outside or the water storage box enters into the steam generating cavity. The heating element at the bottom of the steam generator heats the cold water in the steam generating cavity as steam to be used for ironing clothes, etc. The heating element is a U-shaped heating tube. The heating element needs to heat all of water in the steam generating cavity, and then the steam can be sprayed out.

For example, a prior art of patent number U.S. Pat. No. 10,273,629B1 has disclosed “handheld steam ironing machine with multiple water inlet points and multi-cavity isolated water paths”. The above invention provides an independent first accommodating cavity and a second accommodating cavity, as well as a temperature sensor, to prevent condensation water from being generated on the ironing board when the handheld steam ironing machine is working, and to solve the problem of water spraying due to too much water on one side when the handheld steam ironing machine is turned sideways. However, the above-mentioned invention only has a single accommodating cavity for heating, and there is no other preheating cavity or reheating cavity. Therefore, the heating process takes a long time and the water in the cavity is easily heated unevenly, and the heating path of the heating body in the accommodating cavity is short, the time of heat provided is short, so it is difficult for the water to be sufficiently vaporized.

### SUMMARY OF THE PRESENT UTILITY PATENT

The present utility patent aims to provide a steam generator in view of the defects and shortcomings of the prior art. The heat conduction base is provided with heating cavities on the upper and lower sides of the heating device, which prolongs the heating range and makes the heating and vaporization more fully. The resistance of two heating device is connected to the power supply in different voltages, so that the corresponding heating device can be switched according to different voltages, making the voltage adaptability of the steam generator stronger.

To achieve the above purpose, the technical solutions adopted in the present utility patent are: a steam generator includes a heat conduction base, a first heating device and a second heating device; wherein the heat conduction base is provided with a nozzle area, and the first heating device and the second heating device are embedded in the middle of the heat conduction base; a first heating cavity is arranged below the first heating device and the second heating device on the heat conduction base; a second heating cavity is arranged above the first heating device and the second heating device on the heat conduction base; a water inlet is arranged on the first heating cavity; the heat conduction base is provided with a steam outlet connecting with the first heating cavity and the second heating cavity; the first heating cavity is provided with a plurality of first heating compartments connected in sequence from the water inlet to the steam outlet; the second heating cavity is provided with a plurality of second heating compartments connected in sequence from the steam outlet to the nozzle area.

Optionally, the first heating device and the second heating device are both in semi-ring shape, and the first heating device and the second heating device are concentrically arranged.

Optionally, both the first heating compartment and the second heating compartment are composed of a plurality of division boards for separating water flow.

Optionally, a plurality of splitter plates for dividing water flow are arranged on two opposing division boards in the first heating compartment.

Optionally, each first heating compartment includes a first cavity, a second cavity and a third cavity arranged sequentially from inside to outside; one end of the first cavity is connected with the water inlet, the second cavity and the third cavity are concentrically arranged as semi-ring shape; a first channel is connected between the first cavity and the second cavity, and a second channel is connected between the second cavity and the third cavity.

Optionally, each second heating compartment includes a fourth cavity, a fifth cavity, a sixth cavity, a seventh cavity and an eighth cavity connected in sequence; the fourth cavity is connected with the steam outlet, the fifth cavity is parallel to the fourth cavity, the sixth cavity is parallel to the fifth cavity, the seventh cavity is parallel to the sixth cavity, and the eighth cavity encircles with the fourth cavity, the fifth cavity, the sixth cavity and the seventh cavity.

Optionally, the nozzle area is located on one side of the heat conduction base away from the seventh cavity; the nozzle area is penetrated by a plurality of blow holes going through the eighth cavity.

Adopting the above technical solutions, the beneficial effect of the present utility patent is: the steam generator includes a heat conduction base, a first heating device and a second heating device. The heat conduction base is provided with a nozzle area, and the heat conduction base is provided with a first heating cavity and a second heating cavity; the first heating cavity is located below the first heating device and the second heating device, the second heating cavity is located above the first heating device and the second heating device. The first heating cavity is arranged to preheat and vaporize the cold water. The setting of the second heating cavity further heats and vaporizes the cold water, so that the steam generator vaporizes the cold water more fully. The first heating cavity is provided with a water inlet, and the heat conduction base is provided with a steam outlet connecting the first heating cavity and the second heating cavity. In the first heating cavity, a plurality of first heating compartments connected in sequence are arranged from the water inlet to the steam outlet which extends the heating range of the cold water in the first heating cavity. In the second heating cavity, a plurality of second heating compartments connected in sequence are arranged from the steam outlet to the nozzle area, which further extends the heating range of the liquid preheated and vaporized by the first heating cavity, so that the steam generator can vaporize the liquid more fully.

### BRIEF DESCRIPTION OF THE FIGURES

To better illustrate the technical solutions of the embodiment of the present utility patent or the technical solutions of the prior art, a brief introduction of the figures that need to be used in the embodiment or the description of the prior art will be given below. As it shown below, the figures in the following description are only some embodiments of the present utility patent, for those of ordinary skilled in the art, other figures can also be obtained based on these figures without inventive efforts.

FIG. 1 is a structure schematic view of the present utility patent;

FIG. 2 is a structure schematic view of another direction of the present utility patent;

FIG. 3 is a longitudinal cross-sectional view of the present utility patent;

FIG. 4 is a transverse cross-sectional view of the present utility patent.

### REFERENCE SIGNS IN THE FIGURES

1—heat-conducting base; 2—first heating device; 3—second heating device; 4—nozzle area; A—first heating cavity; B—second heating cavity; C—water inlet; D—steam outlet; 5—division board; 6—splitter plate; G—first cavity; H—second cavity; I—third cavity; J—first channel; K—second channel; M—fourth cavity; N—fifth cavity; O—sixth cavity; P—seventh cavity; Q—eighth cavity; R—blow hole.

### DETAILED DESCRIPTION OF THE EMBODIMENTS

Below is a further detailed description of the present utility patent based on the figures.

The present embodiment only shows an explanation of the present utility patent and it is not a limitation to the present utility patent. The skilled in the art can make modifications to this embodiment as needed without making any creative contributions after reading this specification, which are always protected by the patent law as long as they are within the scope of the claims of the present utility patent.

It should be noted that when an element is called as being “fixed to”, “attached to” or “arranged on” another element, it can be directly on the other element or indirectly on the other element. When an element is called as being “connected to” another element, it can be directly connected to the other element or indirectly connected to the other element.

It should be noticed that the terms “length”, “width”, “top”, “bottom”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

This embodiment relates to a steam generator. The steam generator of the present patent utility can be used for equipment that requires heating and/or steam, such as handheld steam ironing machine, dryers, hairdressers, etc., and all of them can be heated by the steam generator; be applied to some places requiring heating and/or steam such as sauna rooms and boiler rooms; or be installed with a product body on the steam generator for heating and steaming.

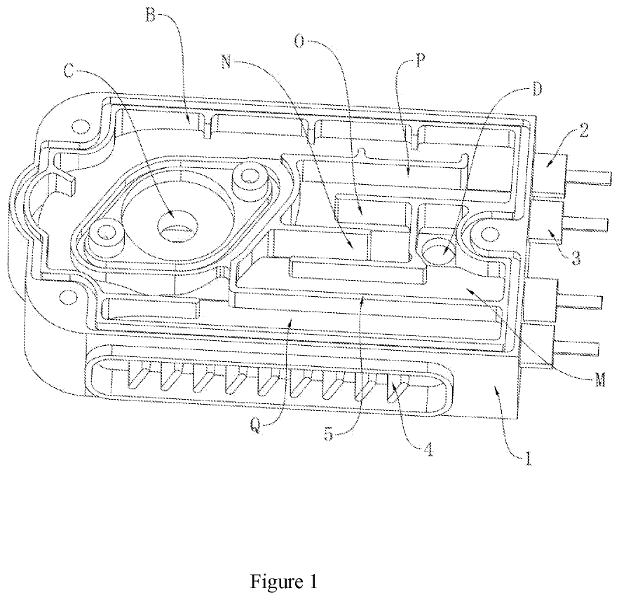

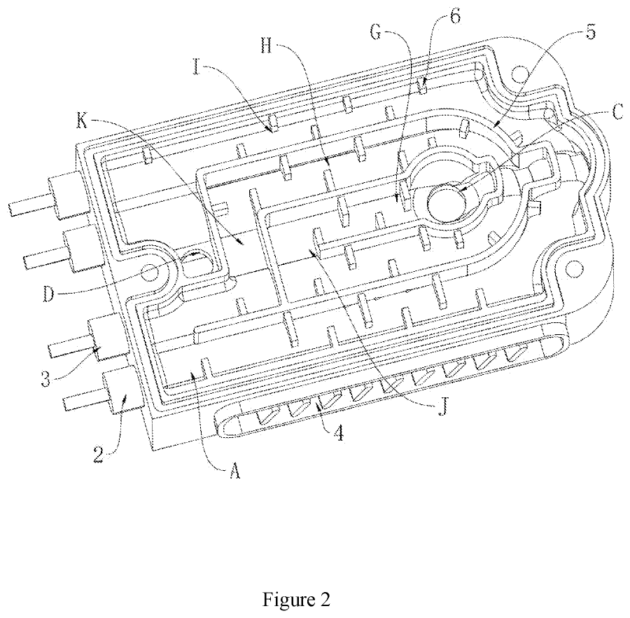

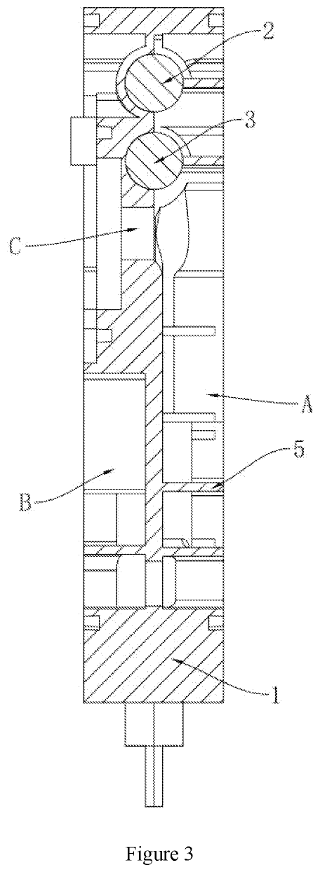

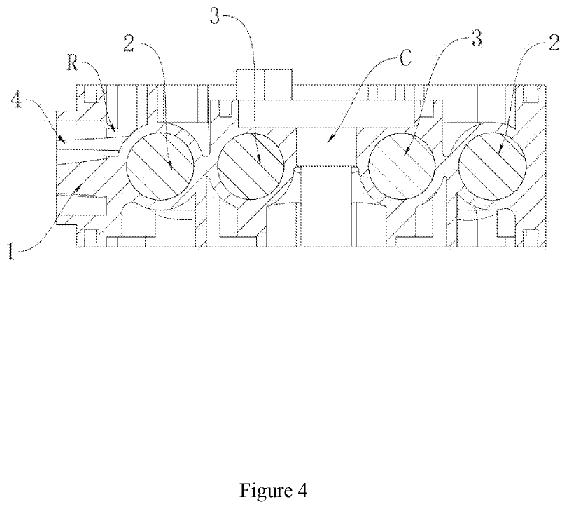

As shown in FIGS. 1-4, the steam generator of this embodiment includes a heat conduction base 1, a first heating device 2 and a second heating device 3. The heat conduction base 1 is provided with a nozzle area 4, and the first heating device 2 and the second heating device 3 are embedded in the middle of the heat conduction base 1. One first heating cavity A is arranged on the bottom of the heat conduction base 1 and below the first heating device 2 and the second heating device 3. One second heating cavity B is arranged on the top of the heat conduction base 1 and above the first heating device 2 and the second heating device 3; the first heating cavity A is located below the first heating device 2 and the second heating device 3, the second heating cavity B is located above the first heating device 2 and the second heating device 3. The configuration of the first heating cavity A realizes the preheating and vaporization of the cold water, and the configuration of the second heating cavity B realizes the further heating and vaporization of the cold water, so that the steam generator vaporizes the cold water more fully. The first heating cavity A is provided with a water inlet C, the heat conduction base 1 is provided with a steam outlet D connecting with the first heating cavity A and the second heating cavity B. The first heating cavity A is provided a plurality of first heating compartments connected in sequence from the water inlet C to the steam outlet D; In this embodiment, in order to make the heat conduction base 1 vaporize the liquid more fully, each first heating compartment is located directly below the first heating device 2 and/or the second heating device 3. The second heating cavity B is provided with a plurality of second heating compartments connected in sequence from the steam outlet D to the nozzle area 4, and each second heating compartment is located directly above the first heating device 2 and/or the second heating device 3, making the heating of the heat conduction base 1 more uniform. A plurality of sequentially connected first heating compartments are arranged in the first heating cavity A, which extends the heating range of the cold water in the first heating cavity A, and a plurality of sequentially connected second heating compartments are arranged in the second heating cavity B, which further extends the heating range of the liquid that has been preheated and vaporized by the first heating cavity A, so that the steam generator can vaporize the liquid more fully.

Optionally, during the application process of the present patent utility, the resistance of the first heating device 2 is adapted to the power supply of 110V-120V, and the resistance of the second heating device 3 is adapted to the power supply of 220V-240V. In some embodiments, the first heating device 2 and the second heating device 3 are respectively connected to the power supply through a switch, so that when the user travels with a handheld steam ironing machine equipped with the steam generator of the present patent utility, the corresponding heating device can be switched according to the local voltage to make the adaptability of the steam generator stronger, so that the handheld steam ironing machine can work stably in different areas with different voltages, preventing the handheld steam ironing machine from not working properly due to low local voltage or avoiding damage and short circuit due to excessive local voltage.

Optionally, the heat conduction base 1 is made of metal with good thermal conductivity, such as copper, aluminum, copper alloy or aluminum alloy, so that when the first heating device 2 and the second heating device 3 generate heat, the heat is transferred to the entire heat conduction base 1, so that the entire heat conduction base 1 is in a heating state.

Optionally, the first heating device 2 and the second heating device 3 are both in semi-ring shape, and the first heating device 2 and the second heating device 3 are concentrically arranged. The first heating device 2 and the second heating device 3 both in a “U” shape. The first heating device 2 and the second heating device 3 are both U-shaped heating tubes.

Optionally, both the first heating compartment and the second heating compartment are composed of a plurality of division boards 5 for separating water flow. The division board 5 and the heat conduction base 1 are integrally formed.

Optionally, in order to increase the contact area between the liquid in the first heating compartment and the heat conduction base 1, thereby increasing the heating area of the liquid in the first heating compartment, and further accelerating the preheating and vaporization rate of the liquid in the steam generator, a plurality of splitter plates 6 for dividing the water flow are arranged on two opposite division boards 5 in the first heating compartment. A plurality of splitter plates 6 are respectively arranged on two opposite division boards 5 in a staggered manner. The top side and one side wall of the splitter plate 6 are integrally formed with the top of the first heating cavity A and the division board 5 respectively.

Optionally, a plurality of first heating compartments include a first cavity G, a second cavity H and a third cavity I arranged sequentially from the inside to the outside. One end of the first cavity G is connected to the water inlet C, and the second cavity H and the third cavity I are concentrically arranged semi-ring shapes. The first cavity G and the second cavity H are connected by a first channel J, and the second cavity H and the third cavity I are connected by a second channel K. Optionally, the first cavity G is in a long strip shape, and the second cavity H and the third cavity I are both in a “U” shape. One end of the first cavity G is connected to the water inlet C, the other end of the first cavity G is connected to one end of the first channel J, the other end of the first channel J is connected to one end of the second cavity H, and the first channel J is in a straight shape. One end of the second channel K is connected to the other end of the second cavity H, and the other end of the second channel K is connected to the third cavity I. The second channel K extends from one end of the second cavity H to other end close to the second cavity H.

It should be noted that the water flow enters into the first cavity G, the first channel J, the second cavity H, the second channel K and the third cavity I in sequence from the water inlet C, and then enters into the second heating cavity B through the steam outlet D.

Optionally, a plurality of second heating compartments include a fourth cavity M, a fifth cavity N, a sixth cavity O, a seventh cavity P and an eighth cavity Q connected in sequence. The fourth cavity M is connected with the steam outlet D, the fifth cavity N is parallel to the fourth cavity M, the sixth cavity O is parallel to the fifth cavity N, the seventh cavity P is parallel to the sixth cavity O, and the eighth cavity Q is used to surround the fourth cavity M, the fifth cavity N, the sixth cavity O and the seventh cavity P. Optionally, the nozzle area 4 is located on one side of the heat conduction base 1 away from the seventh cavity P, and the nozzle area 4 is penetrated by a plurality of blow holes R connected to the eighth cavity Q. It should be noted that a first cover for sealing the first heating cavity A is arranged on the bottom of the heat conduction base 1, and a second cover for sealing the second heating cavity B is arranged on the top of the heat conduction base 1.

It should be noted that the sequentially connected fourth cavity M, fifth cavity N, sixth cavity O, seventh cavity P and eighth cavity Q extend the heating range of the liquid which is preheated and vaporized through the first heating cavity A, which makes the liquid vaporization of the handheld steam ironing machine more fully.

The above only aims to illustrate the technical solution of the present utility patent without limitation. Any other modifications or equivalent replacements of the technical solution of the present utility patent made by ordinary skilled in the art should be included in the scope of the claims of the present utility patent as long as they do not deviate from the technical solution spirit and scope of the present utility patent.

1. A steam generator, comprising: a heat conduction base, a first heating device and a second heating device; wherein the heat conduction base is provided with a nozzle area, and the first heating device and the second heating device are embedded in the middle of the heat conduction base;
a first heating cavity is arranged below the first heating device and the second heating device which on the heat conduction base;
a second heating cavity is arranged above the first heating device and the second heating device on the heat conduction base; and
a water inlet is arranged on the first heating cavity; the heat conduction base is provided with a steam outlet connecting with the first heating cavity and the second heating cavity; the first heating cavity is provided with a plurality of first heating compartments connected in sequence from the water inlet to the steam outlet; the second heating cavity is provided with a plurality of second heating compartments connected in sequence from the steam outlet to the nozzle area.

2. The steam generator according to claim 1, wherein the first heating device and the second heating device are both in semi-ring shape, the first heating device and the second heating device are concentrically arranged.

3. The steam generator according to claim 1, wherein both the first heating compartment and the second heating compartment are composed of a plurality of division boards for separating water flow.

4. The steam generator according to claim 3, wherein a plurality of splitter plates for dividing water flow are arranged on two opposing division boards in the first heating compartment.

5. The steam generator according to claim 1, wherein each first heating compartment further comprises a first cavity, a second cavity and a third cavity arranged sequentially from inside to outside; one end of the first cavity is connected with the water inlet, the second cavity and the third cavity are concentrically arranged as semi-ring shape; a first channel is connected between the first cavity and the second cavity, and a second channel is connected between the second cavity and the third cavity.

6. The steam generator according to claim 1, each second heating compartment further comprising a fourth cavity, a fifth cavity, a sixth cavity, a seventh cavity and an eighth cavity connected in sequence, wherein the fourth cavity is connected with the steam outlet; the fifth cavity is parallel to the fourth cavity; the sixth cavity is parallel to the fifth cavity; the seventh cavity is parallel to the sixth cavity; the eighth cavity encircles with the fourth cavity, the fifth cavity, the sixth cavity and the seventh cavity.

7. The steam generator according to claim 6, wherein the nozzle area is located on one side of the heat conduction base away from the seventh cavity; the nozzle area is penetrated by a plurality of blow holes going through the eighth cavity.
